(19) United States
(12) Patent Application Publication
(10) Pub. No.: US 2009/0298371 A1
(43) Pub. Date: Dec. 3, 2009

(54) WOVEN FABRIC

(75) Inventor: Christoph MAURER, Zurich (CH)

Correspondence Address: Studebaker & Brackett PC, 1890 Preston White Drive, Suite 105, Reston, VA, 20191, US

(73) Assignee: SEFAR AG FILTRATION DIVISION, Heldon (CH)

(21) Appl. No.: 12/195,666

(22) Filed: Aug. 21, 2008

(30) Foreign Application Priority Data
Mar. 23, 2006 (EP) 06005940.9

(51) Int. Cl. B01D 39/08; D03D 15/08

(52) U.S. Cl. 442/184; 442/164

(57) ABSTRACT

The invention relates to a woven fabric with a stretchable woven fabric structure, which has a high-elastic and a low-elastic yarn, the elasticity of the high-elastic yarn and the low-elastic yarn being chosen differently such that a specific relative movement takes place between the high-elastic yarn and the low-elastic yarn during stretching as intended. In accordance with the invention the low-elastic yarn contains a polyacetal, in particular a polyoxymethylene.

The invention relates to a woven fabric in accordance with the preamble of claim 1.

The invention relates in particular to a woven fabric with a stretchable woven fabric structure, which has a first high-elastic yarn and a second low-elastic yarn having an elasticity that is lower than that of the high-elastic yarn, the elastic of the high-elastic yarn and the at least one further low-elastic yarn being chosen differently such that a specific relative movement takes place between the first yarn and the second yarn during stretching as intended.

EP-B-1 232 780 describes a filter cloth for a cake-forming filtration with a filtration area that has a stretchable fabric structure. The latter consists of a high-elastic monofilament yarn, which has a specific elasticity, and at least one further yarn. The further yarn has an elasticity that is lower than that of the high-elastic monofilament yarn. Through the monofilament yarn and the further yarn a fabric structure with a defined amount of elasticity is formed, which permits a greater stretching of the fabric structure than that of the filter cake formed thereon. Moreover, the elasticity of the high-elastic monofilament yarn and the at least one further yarn are chosen differently such that during stretching as intended a defined relative movement occurs between the yarns of different elasticity.

A woven fabric containing a high-elastic yarn is known from U.S. Pat. No. 6,030,905. In this document various high-elastic yarns with an elasticity of 60% and more are described. The high-elastic synthetic yarn described in detail consists to an amount of at least 70% of a thermoplastic elastomeric copolyetherester. This thermoplastic elastomeric copolyetherester contains at least 95% of a particular polymer. The stretchability of this high-elastic yarn is specified to a degree of up to 110%.

The invention is based on the object to provide a woven fabric that has an especially high self-cleaning effect.

This object is solved by a woven fabric in accordance with claim 1. Advantageous embodiments are stated in the dependent claims.

The woven fabric according to the invention is characterized in that the second low-elastic yarn contains a polyacetal, in particular polyoxymethylene.

As a result of the features according to the invention a woven fabric is provided, which counteracts inclusions of particles to a very high degree.

Generally, the self-cleaning effect is based on the different elasticity of the high-elastic and low-elastic yarns employed. In the case of a mechanical deformation the high-elastic yarns undergo greater stretching than the low-elastic yarns so that these two yarn types are able to move to each other, whereby a relative movement is brought about. A particle, which is in contact with both yarn systems in particular, can thereby experience the application of force and be stripped off or detached from the woven fabric.

In accordance with the invention the second low-elastic yarn contains polyoxymethylene. This forms a very smooth surface and in this way ensures a very low friction coefficient. Fine particles can therefore only deposit themselves on this yarn to a marginal degree.

Moreover, the low friction coefficient leads to a minimum of friction between the yarns. The relative movement between the yarns rendered possible due to the different elasticities can therefore develop in an especially strong manner. All these factors improve the self-cleaning to a significant extent.

In addition to an improved self-cleaning effect resulting from the increased relative movement excellent wear characteristics is also the result thereof. Wear of the woven fabric, in particular during friction of the yarns to one another, is reduced and the service life of the woven fabric is increased.

Furthermore, the smooth surface facilitates the discharge of a filter cake formed thereon, if the woven fabric is employed as a filter medium. In this way, complicated mechanical devices needed for the detachment of the filter cake can be reduced or even dispensed with completely. This brings about not only a cut-back in investment and maintenance costs but also preserves the woven fabric which can suffer damage or become worn out in the case of direct contact with, for example, a doctor blade.

With the woven fabric according to the invention a relative movement between the fibres can be increased further in particular through an inflation or other comparable deformations, whereby the self-cleaning effect of the woven fabric is improved. Especially inclusions of very fine particles, which preferably develop at crossing points of warp and weft threads and are relatively difficult to remove, can be detached and removed to a particularly high degree in the woven fabric according to the invention through simple stretching or fulling movements.

In particular the solid particles that deposit themselves on the crossing points of the yarns can thereby be detached and stripped off. Through simple mechanical movements, such as tapping, fulling or the passage of air, the woven fabric according to the invention can be freed rapidly from included micro particles. In this manner the frequency and intensity of a potential additional wet cleaning can be curtailed resulting in a reduction of the related cleaning costs.

In addition, due to the reduced frequency of wet cleaning by using in part very aggressive cleaning chemicals the woven fabric is subjected to less strain and therefore a cost-intensive wearing of the material is diminished. What is more, the impact on the environment can thereby be decreased noticeably.

Polyoxymethylene, which is preferably contained in the second low-elastic yarn with a proportion of 30% to 100%, is a thermoplastic material that can be obtained through polymerization of formaldehyde. The basic material formaldehyde is preferably obtained through oxidation of methanol which can be produced on a large technical scale at low cost.

It is also possible to use a low-elastic yarn of a different material that is provided with a polyoxymethylene coating.

In a preferred embodiment of the woven fabric according to the invention the polyoxymethylene is present in the form of a copolymer. Compared to homopolymers copolymers have a higher chemical and thermal stability. More particularly, copolymers possess a higher resistance to alkalis and are less affected by a long-term exposure to humidity at an increased temperature. Copolymerization preferably takes place by means of trioxane with e.g. 0.1 to 15 mol/%, cyclical ethers such as ethylene oxide or 1,3-dioxolane. By preference, copolymerization of trioxane is carried out in the melt with e.g. boron trifluoride/dibutylether as catalyst.

Through the choice of the further comonomer components it is possible to specifically influence fundamental properties of the copolymer, such as in particular elasticity, frictional resistance, abrasion resistance as well as resistance to chemicals. Suitable comonomers can be chosen from styrene, acrylic ester, acrylonitrile, amide, butadiene, sulfones and ethersulfones.

It is of advantage if the polyoxymethylene constitutes a component of a polymer blend. Through a combination with other polymers a wider range of mechanical and physical-chemical properties is opened up, which can be added to the low-elastic yarn. For example through a combination with thermoplastic polyurethane elastomers it is possible to produce polymer blends with a high impact resistance. As polymer blend component other thermoplastics such as in particular polyamides, polystyrenes and polyethylenes are suitable, too.

Preferably, further high-elastic and/or low-elastic yarns are provided in the woven fabric. In this manner the mechanical properties of the woven fabric, especially the stretchability, can be varied in a defined way and also adapted locally different.

In particular, by way of combinations of yarns having a different elasticity it is possible to produce any intended type of elasticity profile. It is also possible to produce a strong direction-dependent elasticity, which is of advantage e.g. in the use as a filter belt. Moreover, the permeability of the woven fabric can thereby be changed specifically for different media. In addition, further additives as for example glass fibres, minerals, slip additives, pigments, conductive fillers or stabilizers can be added to the polymer of the low-elastic yarn for the purpose of specific adjustment of the stability, colour, slip resistance or electric conductivity.

By preference, the high-elastic yarn is produced of polyester, polyurethane, polyolefin, polyamide and/or their copolymers, especially copolyetherester. Copolyetherester is a synthetic copolymer which has excellent properties with regard to strength, elongation at break, knot strength and in particular with regard to permanent elasticity.

In a further preferred embodiment the high-elastic yarn has a tensile stress coefficient C₁₀₀ of at least 0.50, preferably ranging between 0.60 and 0.90, and the low-elastic yarn has a tensile stress coefficient C₁₀₀ of less than 0.50, preferably ranging between 0.1 and 0.3. By preference, the ratio of elasticity of the different yarns is 2:1 and higher. The tensile stress coefficient Cₙ can be determined according to the German industrial standard DIN 53835 and is a measure for the elasticity and long-term dimensional stability of the yarn, with n indicating the number of stretch cycles.

As a result of the different elasticities for the high-elastic and low-elastic yarn a sufficiently high relative movement between the individual yarn types is brought about. As fibre material for the high-elastic yarn use can be made of the material Elas-Ter (registered trade mark of the company Hoechst Trevira GmbH & Co. KG) for example. Other monofilaments consisting of a thermoplastic elastomeric copolyetherester can also be employed that have a tensile stress coefficient C₁₀₀ of approximately 0.7.

In addition, it is of advantage if the high-elastic yarn and/or the low-elastic yarn are present as monofilament yarns. Due to the fact that the monofilament yarns have very smooth surfaces, the inclusion of small particles in the woven fabric structure is reduced considerably so that monofilament woven fabrics have a noticeably lower tendency to clogging and, in addition, they can be cleaned better. For example by passing through a blast of compressed air remaining proportions of fine particles in the woven fabric can be blown off.

Especially monofilaments consisting of polyoxymethylene have a number of highly advantageous properties.

Firstly, the modulus can be adjusted in the range of 4-8 N/tex. Moreover, the elongation at break can also be adjusted in the range of 5-20%. In addition, it is possible to produce the fibres with a diameter ranging from 0.04 to approximately 0.4 mm.

On account of the good variability of a number of fundamental mechanical properties the woven fabric can be optimized selectively for specific applications.

Another fundamental advantage of the woven fabric according to the invention can be seen in the fact that monofilament elastic fabrics have a much lower elasticity fatigue as compared to multifilament elastic fabrics. This means that the monofilament elastic fabrics keep their form-recovering properties over a longer period of time and that fabric deformations caused by permanent overstretching can be avoided. In this way a wrinkling in the woven fabric and therefore a premature fabric breakage can be prevented.

Finally, woven fabrics made of monofilament yarn also show significant improvements with regard to abrasion resistance as compared to woven fabrics made of multifilament elastic yarns.

In a particularly simple embodiment of the invention the warp threads of the woven fabric structure are formed of the low-elastic yarn and the weft threads are formed of the high-elastic yarn.

A woven fabric of such kind has a strong direction-dependant elasticity, which may be of advantage in the use as a filter belt for example.

Finally, considerably improved cleaning properties of the woven fabric can be achieved in that at least one surface of the woven fabric is calendered or provided with a coating for refinement of the surface. Besides, the respective yarns can also be provided with an additional anti-adhesive coating.

By preference, the woven fabric structure has twill weaves and/or satin weaves. In the case that specific mechanical properties of the woven fabric or specific permeation properties are required, double-layer and multi-layer woven fabrics in different fabric weaves are possible, too. By combining elastic and regular yarns in all fabric directions and/or alternately in a particular direction any intended elasticity profiles can be produced.

The woven fabric in accordance with the invention can be used for the production of a filter medium, in particular a filter bag for disc filters.

In specific cases a balloon-like inflation is caused in a filter medium for the discharge of a filter cake. These effects can be enhanced considerably by the use of high-elastic yarns, especially monofilament yarns. Thus, in the filter medium according to the invention surface extensions of ΔA: A>=0.02 are possible. In the case of a filter medium having the geometry of a filter bag the latter is manufactured in the shape of a disc segment. Due to the elastic material the narrow opening located at the bottom of the bag can be pulled onto a segmental frame whilst still resting well on a support surface.

The invention can preferably be applied to filters of the cake-forming filtration, in which a device for blowing off the filter cake from the rear of the filtration area is provided.

To lift a filtration area of the filter medium from a support surface a stretchable woven fabric structure can be provided at least in the filtration area. At least in the filtration area low-elastic and high-elastic monofilament yarns according to the invention can be incorporated selectively into the woven fabric structure.

In a further embodiment of the filter medium according to the invention the woven fabric structure is designed in an inflatable manner in the filtration area. More particularly, a balloon-like inflation can be provided. Here the detachment of the filter cake is not only brought about by the escaping air but also by the considerable stretching of the filter cake surface. The stretching can be chosen between 2% and 80%, with this stretching being greater than that of the filter cake. In addition, a further self-cleaning of the filter medium can be achieved as a result of the balloon effect, wherein the reason for this self-cleaning effect can be considered to reside in a fulling process between adjoining yarns in the filter cloth, i.e. a relative movement of adjoining yarns.

The invention can preferably be applied to filters of the cake-forming filtration, in which a device for blowing off the filter cake from the rear of the filtration area is provided.

1. A woven fabric with a stretchable woven fabric structure, which has a high-elastic yarn and a second low-elastic yam having an elasticity that is lower than that of the high-elastic yarn, the elasticity of the high-elastic yarn and the at least one further low-elastic yarn being chosen differently such that a specific relative movement takes place between the first yam and the second yam during stretching as intended,
wherein the second low-elastic yarn contains a polyacetal, in particular a polyoxymethylene, and
the high-elastic yarn is produced of copolyetherester.

2. Woven The woven fabric according to claim 1, wherein the polyoxymethylene is present in the form of a copolymer.

3. The woven fabric according to claim 1, wherein the polyoxymethylene is a component of a polymer blend.

4. The woven fabric according to claim 1, wherein further high-elastic and/or low-elastic yams are provided.

5. The woven fabric according to claim 1, wherein the high-elastic yarn has a tensile stress coefficient C₁₀₀ of at least 0.50, preferably ranging between 0.60 and 0.90, and the low-elastic yam has a tensile stress coefficient C₁₀₀ of less than 0.50, preferably ranging between 0.1 and 0.3.

6. The woven fabric according to claim 1, wherein the high-elastic yarn and/or the low-elastic yarn are present as monofilament yarns.

7. The woven fabric according to claim 1, wherein the warp threads of the woven fabric structure are formed of the low-elastic yam and the weft threads are formed of the high-elastic yarn.

8. The woven fabric according to claim 1, wherein at least one surface of the woven fabric is calendered or provided with a coating for refinement of the surface.

9. The woven fabric according to claim 1, wherein the woven fabric structure has twill weaves and/or satin weaves.

10. A filter medium, in particular filter bag for disc filters, which has a woven fabric according to claim 1.
